(19) United States
(12) Patent Application Publication
(10) Pub. No.: US 2015/0156237 A1
(43) Pub. Date: Jun. 4, 2015

(54) Video Streaming System, Computer Device, and Video Streaming Method

(71) Applicant: AVerMedia TECHNOLOGIES, INC., NEW TAIPEI CITY (TW)

(72) Inventors: Chien-Ming HUANG, TAIPEI HSIEN (TW); Shih-Hsiung LEE, TAIPEI HSIEN (TW)

(73) Assignee: AVerMedia TECHNOLOGIES, INC., NEW TAIPEI CITY (TW)

(21) Appl. No.: 14/095,979

(22) Filed: Dec. 3, 2013

(51) Int. Cl. H04L 29/06

(52) U.S. Cl. CPC H04L 65/60

(57) ABSTRACT

A video streaming system includes a mobile device and a computer device. The mobile device includes a camera module, a mobile network module, and a client module. The camera module captures the video data. The client module is electrically connected the camera module and the mobile network module, controls the operation of the camera module, compresses the video data into the streaming data, and transmits the streaming data through the mobile network module. The computer device includes a computer network module and a virtual device. The computer network module is connected to the mobile network module. The virtual device is electrically connected to the computer network module. When the computer network module network is connected to the mobile network module through the network, the computer network module receives the streaming data transmitted by the client module and decompresses the streaming data to restore the video data.

### BACKGROUND

1. Field of Invention

The present invention relates to a video streaming technology. More particularly, the present invention relates to a video streaming system, a computer device, and a video streaming method for using a photographic lens of a mobile device as a wireless video data source of the computer device.

2. Description of Related Art

The speed of the information communication is promoted with the development of the network generation. The data transmitted by network is from words and sounds in the early years to the video data transmitted through the network in the recent years. This is why that the service and the application of the video streaming (e.g., Youtube, Netflix, Twitch.TV) have a great boom. The provider of the video data changes from the television station or the movie company in the early years to the average people in the recent years.

At the same time, because the wireless network is convenient, the mobile device (e.g., the smart mobile phone, the tablet computer) with network connection replaces the feature phone gradually. Because the popularization rate of the mobile phone with network connection also the photographic lens is higher and higher, some streaming service agents (e.g., USTREAM) develops the applications that the contents captured by the photographic lens of the mobile device are provided to view for the viewers. The application of the mobile device controls the photographic lens to record the video data and streams the video data to the servers of the streaming service agents, and the viewers may link to the websites of the streaming service agents to view the video data provided by the video data provider.

The applications as above may only be used for the video data streaming. If the video data would like to be done the further postproduction, the video data must be saved as the file after recording, copied to the computer device, and processed the video postproduction by the video editing software. It is worse in timeliness and convenience.

The conventional video streaming system and video streaming method cannot transmit the video data that is being recorded to the computer device through streaming and process the video postproduction directly. Therefore, it is one of the important subjects and the objective needs to take the photographic lens of the mobile device as the video data source, to transmit through the network and view on the computer device directly and further to do the video postproduction.

### SUMMARY

A video streaming system, a computer device, and a video streaming method are provided to resolve the problems met in the art.

According to an embodiment of the present invention, the video streaming system includes a mobile device and a computer device. The mobile device includes a camera module, a mobile network module, and a client module. The camera module is configured to capture video data. The client module is electrically connected to the camera module and the mobile network module, and it is configured to control the operation of the camera module, compress the video data into streaming data, and transmit the streaming data through the mobile network module. The computer device includes a computer network module and a virtual device. The computer network module is configured to the mobile network module. The virtual device is electrically connected to the computer network module. The virtual device is configured to simulate as a video capture device realized by software, and it receives the streaming data transmitted by the client module and decompresses the streaming data to restore the video data when the computer network module is connected to the mobile network module through the network.

In an embodiment, the virtual device controls the operation of the camera module to capture the video data through the client module when the computer network module is connected to the mobile network module through the network.

In an embodiment, the computer device further includes a video processing module and a video postproduction module. The video processing module is electrically connected to the virtual device. The video postproduction module is electrically connected to the video processing module and configured to process the video data. The video processing module processes the video data restored by the virtual device to serve as compatible video data for the video postproduction module.

In an embodiment, the client module starts compressing the video data into the streaming data and transmits the streaming data through the mobile network module when the client module controls the camera module to start capturing the video data. The client module stops compressing the video data into the streaming data and stops transmitting the streaming data when the client module controls the camera module to stop capturing the video data.

According to an embodiment of the present invention, the computer device includes a computer network module and a virtual device. The virtual device is electrically connected to the computer network module. The virtual device is configured to simulate as a video capture device realized by software, and the virtual device received streaming data transmitted by a mobile device and decompressed the streaming data to restore video data when the computer network module is connected to the mobile network module through the network. The streaming data is compressed from the video data captured by a camera module of the mobile device through a client module of the mobile device.

In an embodiment, the virtual device controls the operation of the camera module to capture the video data through the client module when the computer network module is connected to the mobile device through the network.

In an embodiment, the computer device further includes a video processing module and a video postproduction module. The video processing module is electrically connected to the virtual device. The video postproduction module is electrically connected to the video processing module. The video processing module processes the video data restored by the virtual device to serve as compatible video data for the video postproduction module.

In an embodiment, the client module of the mobile device is configured to control the operation of the camera module. The mobile device transmits the streaming data through a mobile network module.

In an embodiment, the client module starts compressing the video data into the streaming data and transmits the streaming data through the mobile network module when the client module controls the camera module to start capturing the video data, and the client module stops compressing the video data into the streaming data and stops transmitting the streaming data when the client module controls the camera module to stop capturing the video data.

According to an embodiment of the present invention, the video streaming method includes: capturing video data through a camera module of a mobile device; compressing the video data into streaming data; transmitting the streaming data through the network; receiving the streaming data through a virtual device installed on a computer device when the computer device is connected to the mobile device through the network, and wherein the virtual device is configured to simulate as a video capture device and realize by software; and decompressing the streaming data through the virtual device to restore the video data.

In an embodiment, the virtual device of the computer device controls the operation of the camera module to capture the video data through a client module of the mobile device when the computer network module is connected to the mobile device through the network.

In an embodiment, the video streaming method further includes processing the restored video data to serve as compatible video data for the computer device.

In an embodiment, the video data start to be compressed into the streaming data and the streaming data are transmitted through the network when the camera module starts capturing the video data, and the video data are not compressed into the streaming data and the streaming data are not transmitted when the camera module stops capturing the video data.

In summary, the present invention has significant advantages and higher performance than current technology. With the present invention, we have significant improvement in video streaming techniques, and it is worthwhile to be widely used and implemented in industry. Advantages of the present invention are to use the photographic lens of the mobile device as the video data source, transmit through the computer device for viewing, and even process the postproduction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a video streaming system according to an embodiment of the present invention;

FIG. 2 is a schematic diagram of the video streaming system according to an embodiment of the present invention; and

FIG. 3 is a flow chart of a video streaming method according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. In addition, the well-known components and steps are not described in the embodiments to avoid unnecessary limitations to the present invention.

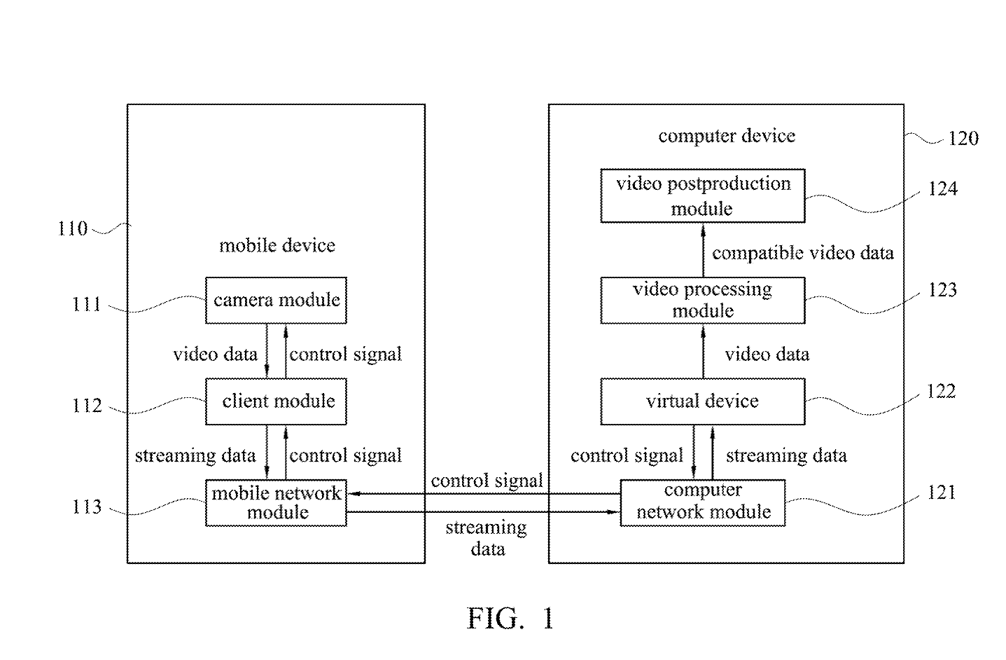

In the video streaming system of the present invention, the photographic lens of the mobile device (e.g., the smart mobile phone) is utilized as a source for getting video data, and the video data are transmitted to the computer device (e.g., the desktop computer, the notebook computer) through the network. FIG. 1 is a block diagram of a video streaming system according to an embodiment of the present invention. As shown in FIG. 1, the video streaming system includes a mobile device 110 and a computer device 120. The mobile device 110 includes a camera module 111, a client module 112, and a mobile network module 113. In structure, the mobile device 110 is the smart mobile phone, the camera module 111 is electrically connected to the client module 112, and the client module 112 is electrically connected to the mobile network module 113. The mobile network module 113 can be connected to the device that waits to receive the streaming data through the network; for example, the device is the computer device such as a desktop computer and a notebook computer.

In practice, the camera module 111 is configured to capture the video data. For example, the camera module 111 can be the photographic lens of the smart mobile phone. Within the duration, the photographic lens can capture the image and the sound within a visual range. The data that is composes of the image and the sound is video data. The photographic lens of the smart mobile phone can be controlled through the applications and the hardware keys controlled the photographic lens on the smart mobile phone. The client module 112 can control the operation of the camera module 111. For example, the client module 112 is at least one application that can start the photographic lens of the smart mobile phone on the smart mobile phone, and it can control the photographic lens to capture the video data. When the photographic lens captures the video data, the application can control the photographic lens to adjust the parameters such as the zoom in multiple ratios, the zoom out multiple ratios, and the color adjustment. For example, if the operating speed and precision are both the first considerations, the client module 112 may be mainly implemented in hardware and/or firmware. If design flexibility is the first consideration, the client module 112 is mainly implemented in software. Alternatively, these modules operate with the collaboration of software, hardware, and firmware. It should be understood that none of the above examples is more preferable than any of the other examples, nor are they intended to limit the scope of the invention. Those skilled in the art may specifically implement the client module 112 with flexibility according to the requirements then. For example, the client module 112 is a central processing unit (CPU).

If the general users would like to process (e.g., the effect and dynamic tracking of the video) the video data captured by the camera module 111 of the mobile device 110, the users must wait to finish capturing the video data and save as the video file, then copy to the computer device 120, use the video postproduction software (e.g., Adobe Premiere Pro, AverCaster) to process the procession for the video file. The video streaming system of the present invention is to us the streaming technology to transmit the video data captured by the camera module 111 for the users that know well the video postproduction software or to apply the video file can receive the video data real time, i.e., the users can transmit the video data to the computer device 120 directly, not need to wait the video data finishing capturing. After the client module 112 receives the video data captured by the camera module 111, the video data will be compressed into a streaming data. When the mobile network module 113 is connected to a device that is waiting to receive the streaming data, the client module 112 transmits the streaming data to the device received the streaming data. The client module 112 is included in the central processing unit (CPU). The mobile network module 113 is a near field communication device such as a bluetooth module, a RF module, a Wi-Fi module, etc., or a telecommunication device such as a 3G communication module, a 4G communication module, etc. The mobile network module 113 is connected to the device received the streaming data through this kind of wireless communication technology.

The computer device 120 includes a computer network module 121 and a virtual device 122. In structure, the computer network module 121 is connected to the mobile network module 113 through the network, and the virtual device 122 is electrically connected to the computer network module 121. In practice, the computer network module 121 is configured to connect to the mobile network module 113, and the computer device 120 is connected to the network through the computer network module 121 then connected to the mobile device 110. The computer network module 121 is the near field communication device such as the bluetooth module, the RF module, the Wi-Fi module, etc., or the telecommunication device such as the 3G communication module, the 4G communication module, etc. The computer network module 121 is connected to the mobile network module 113 through this kind of wireless communication technology. The virtual device 122 is configured to receive the streaming data transmitted by the client module 112 and to decompress the streaming data to restore the video data when the computer network module 121 is connected to the mobile network module 113 through the network. The virtual device 122 is included in the central processing unit (CPU).

In an embodiment, the virtual device 122 is to simulate as a video capture device realized by software, and it may be a computer application program on the computer device 120. The computer network module 121 of the computer device 120 gets a dynamic IP address from the network or has been set its fixed IP address, and the client module 112 is a mobile application program corresponding to the virtual device 122 on the mobile device 110. The mobile network module 113 on the mobile device 110 gets a dynamic IP address from the network or has been set its fixed IP address, and it has a MAC (Media Access Control) Address. In the computer application program, the IP address or MAC address of the mobile network module 113 on the mobile device 110 can be assigned, or using the user login name of the computer application program to connect to the mobile application program that was logged in for the same login name through the network, then the virtual device 122 and the client module 112 can be finished the connection through the network. The virtual device 122 and the client module 112 as mentioned previously may be specifically implemented in software or hardware and/or firmware. For example, if the operating speed and precision are both the first considerations, these modules may be mainly implemented in hardware and/or firmware. If design flexibility is the first consideration, these modules are mainly implemented in software. Alternatively, these modules operate with the collaboration of software, hardware, and firmware. It should be understood that none of the above examples is more preferable than any of the other examples, nor are they intended to limit the scope of the invention. Those skilled in the art may specifically implement the virtual device 122 and the client module 112 with flexibility according to the requirements then.

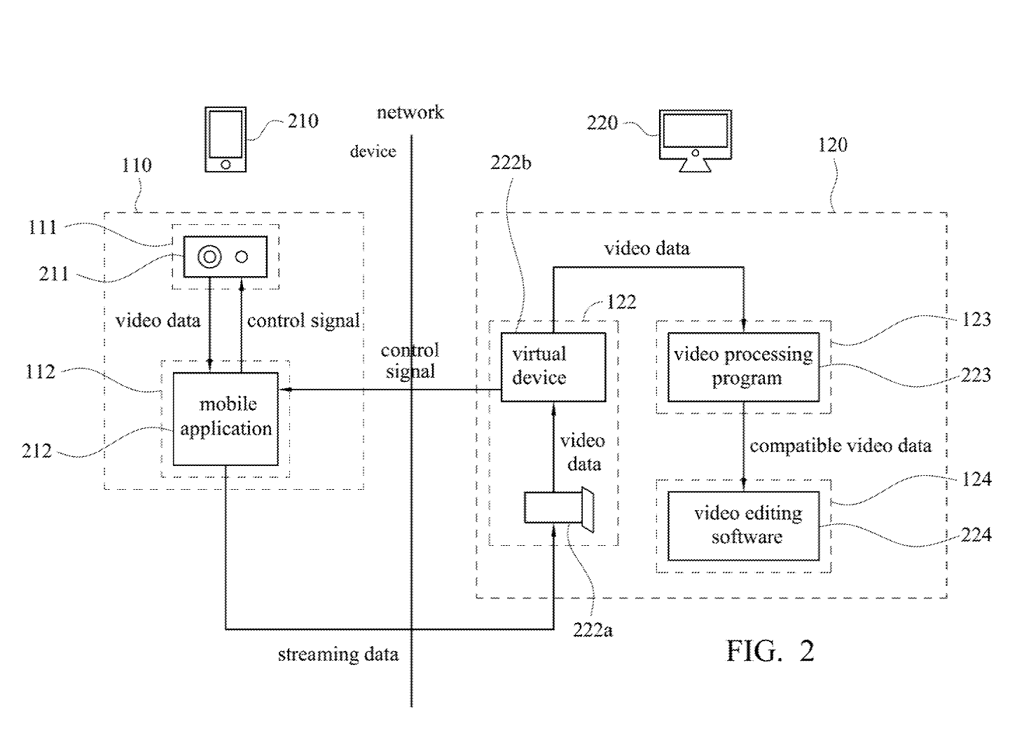

FIG. 2 is a schematic diagram of the video streaming system according to an embodiment of the present invention. As shown in FIG. 2, the mobile device 110 is a smart mobile phone 210, the camera module 111 of the mobile device 110 is a photographic lens 211 of the smart mobile phone 210, and the client module 112 of the mobile device 110 is a the mobile application 212 of the smart mobile phone 210. On the other hand, the computer device 120 is a desktop computer 220. The virtual device 122 of the computer device 120 is composed of an image capture module 222a and a corresponding user interface 222b. For example, when the computer device 220 is additionally connected to a video camera, the video data captured by a lens of the video camera will be transmitted to the image capture module 222a. The users can control the operation (e.g., starting capturing, stopping capturing, zoom in, zoom out, color adjustment) of the lens on the video camera for capturing the video data on the user interface 222b corresponding to the image capture module 222a. The video streaming system of the present invention is to take the video data captured by the photographic lens 211 of the smart mobile phone 210 as the data source, and the video data is compressed into the streaming data through the mobile application 212. The streaming data is transmitted to the image capture module 222a of the desktop computer 220 through the network. The user interface 222b corresponding to the image capture module 222a compresses the streaming data received by the image capture module 222a, so the video data captured by the photographic lens 211 of the smart mobile phone 210 is stored.

As shown in FIG. 1 and FIG. 2, in an embodiment, when the computer network module 121 is connected to the mobile network module 113 through the network, the virtual device 122 may send a control signal to the client module 112 and control the operation of the camera module 111 to capture the video data through the client module 112. For example, after the desktop computer 220 restores the video data captured by the photographic lens 211 of the smart mobile phone 210, the user interface 222b corresponding to the image capture module 222a of the desktop computer 220 may be linked to the mobile application 212 through the network. The users can send the control signal through the mobile application 212 to control the operation (e.g., starting capturing, stopping capturing, zoom in, zoom out, color adjustment) of the photographic lens 211 of the smart mobile phone 210 for capturing the video data on the user interface 222b corresponding to the image capture module 222a of the desktop computer 220.

After the computer device 120 restores the video data captured by the camera module 111 of the mobile device 110, the users can use the video postproduction software (e.g., Adobe Premiere Pres. AverCaster) to do the further postproduction (e.g., the effect and dynamic tracking of the video) for the video data so that the video data can be done the various application. When the video file format of the video data is not the format used by the video postproduction software directly, the computer device 120 must convert the file format of the video data then provide to the video postproduction software to do the further postproduction. In an embodiment, the computer device 120 further includes a video processing module 123 and a video postproduction module 124.

In structure, both the video processing module 123 and the video postproduction module 124 are set on the computer device 120, the video processing module 123 is electrically connected to the virtual device 122, and the video postproduction module 124 is electrically connected to the video processing module 123. In an embodiment, the video processing module 123 and the video postproduction module 124 may be included in an image processing card. In practice, the video processing module 123 converts the video data restored by the virtual device 122 of the computer device 120 into the compatible the video data of the video postproduction module 124. As shown in FIG. 2, in an embodiment, the video processing module 123 may be a video processing program 223 that includes the DirectShow technology, and the video postproduction module 124 may be a video editing software 224. When the video postproduction module 124 is Adobe Premiere Pro software, the video processing module 123 takes the DirectShow technology to convert the video data restored by the virtual device 122 into the video file format (e.g., AVI file format, MPEG file format, WAV file format) that Adobe Premiere Pro software can load. When the video postproduction module 124 is AverCaster software, the AverCaster software may take the DirectShow technology to receive the video data restored by the virtual device 122 then do postproduction for the compatible the video data. The video processing module 123 and the video postproduction module 124 as mentioned previously may be specifically implemented in software or hardware and/or firmware. For example, if the operating speed and precision are both the first considerations, these modules may be mainly implemented in hardware and/or firmware. If design flexibility is the first consideration, these modules are mainly implemented in software. Alternatively, these modules operate with the collaboration of software, hardware, and firmware. It should be understood that none of the above examples is more preferable than any of the other examples, nor are they intended to limit the scope of the invention. Those skilled in the art may specifically implement these modules with flexibility according to the requirements then.

The client module 112 on the mobile device 110 may control the starting operation and the stopping operation of the camera module 111 to capture the video data. In an embodiment, when the client module 112 controls the camera module 111 to start capturing the video data, the client module 112 starts compressing the video data into the streaming data and transmitting the streaming data through the mobile network module 113. When the client module 112 controls the camera module 111 to stop capturing the video data, the client module 112 stops compressing the video data into the streaming data and stops transmitting the streaming data through the mobile network module 113. In another embodiment, when the computer network module 121 is connected to the mobile network module 113 through the network, the virtual device 122 may send the control signal to the client module 112 and control the starting operation and the stopping operation of the camera module 111 for capturing the video data to capture the video data through the client module 112.

In an embodiment, the computer device 120 of the present invention includes the computer network module 121 and the virtual device 122. As shown in FIG. 1, in structure, the computer device 120 may be connected to at least one mobile device 110 that is connected to the network through the computer network module 121, and the virtual device 122 is electrically connected to the computer network module 121. The computer network module 121 is the near field communication device such as the bluetooth module, the RE module, the Wi-Fi module, etc., or the telecommunication device such as the 3G communication module, the 4G communication module, and etc. The virtual device 122 is configured to connect to the mobile device 110 through the kind of the wireless communication technology. The virtual device 122 may be the computer application program on the computer device 120. In practice, the virtual device 122 is configured to simulate as a video capture device realized by way of the software. The virtual device 122 receives the streaming data transmitted by the mobile device 110 and decompresses the streaming data to restore the video data when the virtual device 122 is connected to the mobile device 110 through the network. The streaming data is compressed from the video data captured by the camera module 111 of the mobile device 110 through the client module 112 of the mobile device 110.

As shown in FIG. 2, the mobile device 110 is the smart mobile phone 210, and the computer device 120 is the desktop computer 220. In an embodiment, the video data captured by the photographic lens 211 of the smart mobile phone 210 are compressed into the streaming data and transmitted to the desktop computer 220 through the network. The virtual device 122 receives the streaming data transmitted from the mobile device 110 and compresses the streaming data to restore the video data. Since the hardware devices for implementing the video streaming system have been specifically disclosed in the above embodiments, further elaboration is not provided.

As shown in FIG. 1 and FIG. 2, in an embodiment, when the computer network module 121 is connected to the mobile device 110 through the network, the virtual device 122 may send a control signal and control the operation (e.g., starting capturing, stopping capturing, zoom in, zoom out, color adjustment) of the camera module 111 to capture the video data through the client module 112.

After the computer device 120 restores the video data captured by the camera module 111 of the mobile device 110, the users can use the video postproduction software (e.g., Adobe Premiere Pro, AverCaster) to do the further postproduction (e.g., the effect and dynamic tracking of the video) for the video data so that the video data can be used for the various applications. Alternatively, the computer device 120 may convert the file format of the video data first then provide to the video postproduction software to do the further postproduction. In an embodiment, the video streaming system further includes the video processing module 123 and the video postproduction module 124. The video processing module 123 is electrically connected to the virtual device 122, and the video postproduction module 124 is electrically connected to the video processing module 123. In case of need, the video processing module 123 converts the video data restored by the virtual device 122 of the computer device 120 into the compatible the video data of the video postproduction module 124. Since the operations of the video processing module 123 and the video postproduction module 124 have been specifically disclosed in the above embodiments, further elaboration is not provided.

In an embodiment, the client module 112 of the mobile device 110 is configured to control the operation of the camera module 111, and the mobile device 110 transmits the streaming data through the mobile network module 113. The client module 112 of the mobile device 110 may control the camera module 111 the starting operation and the stopping operation to capture the video data. In an embodiment, when the client module 112 controls the camera module 111 to start capturing the video data, the client module 112 starts compressing the video data into the streaming data and transmitting the streaming data through the mobile network module 113. When the client module 112 controls the camera module 111 to stop capturing the video data, the client module 112 stops compressing the video data into the streaming data and stops transmitting the streaming data through the mobile network module 113. In another embodiment, when the computer network module 121 is connected to the mobile network module 113 through the network, the virtual device 122 may send the control signal to the client module 112 and control the starting operation and the stopping operation of the camera module 111 for capturing the video data to capture the video data through the client module 112.

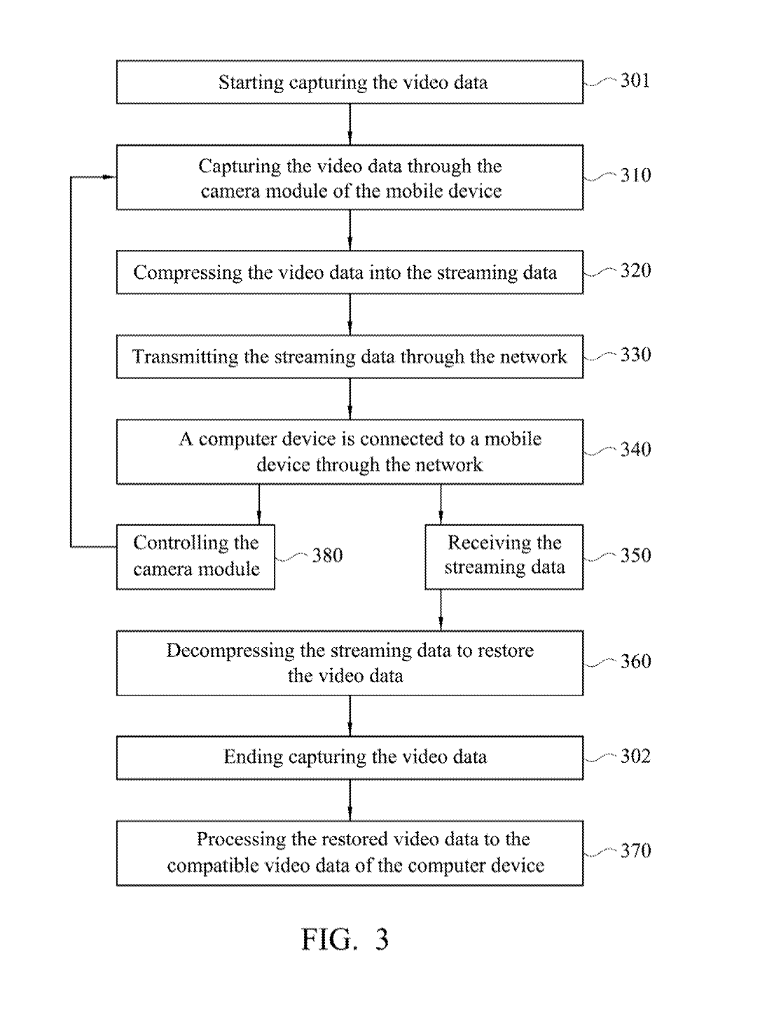

FIG. 3 is a flow chart of a video streaming method according to an embodiment of the present invention. As shown in FIG. 3, in an embodiment, the video streaming method of the present invention includes step 310-360 (it should be understood that the order of the steps mentioned in the present embodiment may be changed based on actual requirement unless otherwise specified, or the steps may even be performed simultaneously or part of the steps may even be performed simultaneously).

In practice, the video streaming method may be implemented through a mobile device and a computer device, such as the mobile device 110 and the computer device 120 as above mentioned. In step 310, the video data that includes the image and the sound are captured through a camera module (e.g., the photographic lens of the mobile) of a mobile device. In step 320, because the video data are taken the streaming technology to transmit, the video data are compressed into the streaming data. In step 330, the streaming data are transmitted through the network. In step 340, a computer device is connected to a mobile device through the network. In step 350, when the computer device is connected to the mobile device through the network, the streaming data are received. In step 360, the streaming data are decompressed to restore the video data.

In step 360, the streaming data are decompressed to restore the video data. When the restored video data need to be done the further postproduction (e.g., the effect and dynamic tracking of the video). The video data must be confirmed if it can be loaded to the video postproduction software to do postproduction. If the format of the video data is not compatible with the video postproduction software, in step 370, the restored video data may be processed to the compatible video data of the computer device. Since the hardware devices for implementing these steps have been specifically disclosed in the above embodiments, further elaboration is not provided.

The operation of the camera module may be controlled to capture the video data through the applications or the hardware control keys of the mobile device. When the mobile device and the computer device are connected through the network, the operation of the camera module can be controlled through not only the applications or the hardware control keys of the mobile device but also the virtual device of the computer device. In step 380, when the computer device is connected to the mobile device through the network, the virtual device of the computer device may send the control signal to control the operation of the capture module for capturing the video data through the client module of the mobile device. Since the hardware devices for implementing these steps have been specifically disclosed in the above embodiments, further elaboration is not provided.

The video streaming method of the present invention may control the starting operation and the stopping operation of the camera module of the mobile device for capturing the video data. In step 301, when the video streaming method controls the camera module to start capturing the video data, the video streaming method will execute step 310-360, i.e., starting compressing the video data into the streaming data and transmitting the streaming data through the network. In step 302, when the video streaming method controls the camera module to stop capturing the video data, the video streaming method stops compressing the video data into the streaming data and stops transmitting the streaming data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A video streaming system, comprising:
a mobile device, comprising:
a camera module configured to capture video data;
a mobile network module; and
a client module electrically connected to the camera module and the mobile network module, and configured to control operation of the camera module, compress the video data into streaming data, and transmit the streaming data through the mobile network module; and
a computer device, comprising:
a computer network module connected to the mobile network module; and
a virtual device electrically connected to the computer network module, configured to simulate as a video capture device realized by software, and the virtual device receives the streaming data transmitted by the client module and decompresses the streaming data to restore the video data when the computer network module is connected to the mobile network module through the network.

2. The video streaming system of claim 1, wherein the virtual device controls the operation of the camera module to capture the video data through the client module when the computer network module is connected to the mobile network module through the network.

3. The video streaming system of claim 1, wherein the computer device further comprises:
a video processing module electrically connected to the virtual device; and
a video postproduction module electrically connected to the video processing module and configured to process the video data;
wherein the video processing module processes the video data restored by the virtual device to serve as compatible video data for the video postproduction module.

4. The video streaming system of claim 1, wherein the client module starts compressing the video data into the streaming data and transmits the streaming data through the mobile network module when the client module controls the camera module to start capturing the video data, and the client module stops compressing the video data into the streaming data and stops transmitting the streaming data when the client module controls the camera module to stop capturing the video data.

5. A computer device, comprising:
a computer network module; and
a virtual device electrically connected to the computer network module, configured to simulate as a video capture device realized by software, and the virtual device receives streaming data transmitted by a mobile device and decompresses the streaming data to restore video data when the computer network module connected to the mobile device through the network;
wherein the streaming data is compressed from the video data captured by a camera module of the mobile device through a client module of the mobile device.

6. The computer device of claim 5, wherein the virtual device controls the operation of the camera module to capture the video data through the client module when the computer network module is connected to the mobile device through the network.

7. The computer device of claim 5, further comprising:
a video processing module electrically connected to the virtual device; and
a video postproduction module electrically connected to the video processing module;
wherein the video processing module processes the video data restored by the virtual device to serve as compatible video data for the video postproduction module.

8. The computer device of claim 5, wherein the client module of the mobile device is configured to control the operation of the camera module, and the mobile device transmits the streaming data through a mobile network module.

9. The computer device of claim 8, wherein the client module starts compressing the video data into the streaming data and transmits the streaming data through the mobile network module when the client module controls the camera module to start capturing the video data, and the client module stops compressing the video data into the streaming data and stops transmitting the streaming data when the client module controls the camera module to stop capturing the video data.

10. A video streaming method, comprising:
capturing video data through a camera module of a mobile device;
compressing the video data into streaming data;
transmitting the streaming data through the network;
receiving the streaming data through a virtual device installed on a computer device when the computer device is connected to the mobile device through the network, and wherein the virtual device is configured to simulate as a video capture device and realize by software; and
decompressing the streaming data through the virtual device to restore the video data.

11. The video streaming method of claim 10, wherein the virtual device of the computer device controls the operation of the camera module to capture the video data through a client module of the mobile device when the computer network module is connected to the mobile device through the network.

12. The video streaming method of claim 10, further comprising:
processing the restored video data to serve as compatible video data for the computer device.

13. The video streaming method of claim 10, wherein the video data start to be compressed into the streaming data and the streaming data are transmitted through the network when the camera module starts capturing the video data, and the video data stop to be not compressed into the streaming data and the streaming data stop to be transmitted when the camera module stops capturing the video data.
